(19) United States
(12) Patent Application Publication
(10) Pub. No.: US 2003/0142237 A1
(43) Pub. Date: Jul. 31, 2003

(54) Video signal provided with advertising

(76) Inventor: Marinus Hendrikus Petrus Cornelis Van Gils, Bavel (NL)

Correspondence Address: Richard L Byrne, 700 Koppers Building, 436 Seventh Avenue, Pittsburgh, PA, 15219-1818, US

(21) Appl. No.: 10/181,375

(22) PCT Filed: Jan. 18, 2001
(86) PCT No.: PCT/NL01/00038

(30) Foreign Application Priority Data
Jan. 18, 2000 (NL) 1014108
Aug. 11, 2000 (NL) 1015925

(51) Int. Cl. H04N 5/445

(52) U.S. Cl. 348/564; 348/565

(57) ABSTRACT

The invention relates to a video-signal, for instance a TV-signal for transmitting via the broadcasting system which is adapted to represent a scene for transmitting via the broadcasting system and which is adapted to reproduce in the scene a part-image which fills a part of the image and which is independent of the scene, wherein the part-image represents an advertising message. This structure provides the option of presenting such a form of advertising instead of an identification symbol of a broadcaster or in addition to such a symbol. The part-image will of course provide only a limited area. It is therefore only possible here to present an identification symbol or logo, brand or the like. In view of the fact that many advertisers only seek brand awareness. this does not have to form a problem per se. According to a first preferred embodiment the part-image is placed in a corner of the image. As experience in broadcasting channel identifications shows, this is a position which is not perceived by the viewer as being very disturbing.

The present invention relates to a video signal, for instance a TV-signal for transmitting via the broadcasting system which is adapted to represent a scene for transmitting via the broadcasting system and which is adapted to reproduce in the scene a part-image which fills a part of the image and which is independent of the scene.

Such a video signal is known in the form of the video signals usually employed at present, which are provided in a top corner with an identifying symbol for the broadcasting company which is transmitting.

Advertising is currently broadcast via the TV-signal in the form of so-called advertising segments which are broadcast between the “normal” programmes, or for which the normal programmes are interrupted.

Particularly this latter configuration is perceived by many viewers as disruptive. During such an interruption viewers usually tend to look for another channel where no advertising is being transmitted at that moment.

This behaviour reduces the effectiveness of advertising. The object of the present invention is to provide a form for presenting advertising in video signals, wherein less irritation is caused among viewers and the advertising is thus more effective.

This object is achieved by such a video signal which is characterized in that the part-image represents an advertising message.

This structure provides the option of presenting such a form of advertising instead of an identification symbol of a broadcaster or in addition to such a symbol. The part-image will of course provide only a limited area. It is therefore only possible here to present an identification symbol or logo, brand or the like.

In view of the fact that many advertisers only seek brand awareness, this does not have to form a problem per se. According to a first preferred embodiment the part-image is placed in a corner of the image. As experience in broadcasting channel identifications shows, this is a position which is not perceived by the viewer as being very disturbing.

According to another preferred embodiment it is possible to place the part-image along a side of the image.

This can be formed by the top part, bottom part or one of the sides.

Account must of course be taken of the fact that when subtitles are being used the bottom part of the image is of course less suitable. It can also be anticipated here that the part-image will be perceived as less disruptive.

Yet another position relates to placing of the part-image in the image, but not connecting to the edge of the image. Although this will in principle cause more disturbance of the original image, particular scenes provide the option of placing a part-image at such a position without this being perceived as disruptive. An example hereof is formed by game shows, wherein scoreboards are usually present in the image. The part-image could be given a place between the scoreboards.

Another measure relates to the changing of location, form or size of the part-image through time. It will be necessary herein to proceed very carefully in order to prevent irritation for the viewer. It is for instance possible to link such a change of the part-image to changes of scene in the programme being broadcast. In such a situation the viewer will experience less irritation, since the change then takes place simultaneously with a general change of scene.

It is of course further possible for the part-image to change through time. Following the logo of a company it is for instance possible to show schematically the products of such a company.

This is of course apart from the situation in which the part-image successively represents advertising messages from different advertisers.

It will be apparent that it is possible to include the part-image in the normal scene intermittently, i.e. in discontinuous manner. It is also anticipated that this will reduce the irritation factor.

According to a preferred embodiment which is attractive from a commercial viewpoint, the part-images anticipate a subsequent advertising message which fills the whole image. It is hereby possible to build up suspense or curiosity about the subsequent advertising message. According to another preferred embodiment which is attractive from a commercial viewpoint, the part-images anticipate the scene being shown at the same moment in order to intensify the effect of the advertising message.

Another preferred embodiment teaches that the signal comprises an electronic reference to a teletext page. In a device suitable for this purpose the relevant teletext page can for instance be activated by pressing a button on the remote control. The advertiser can then focus attention on his products without too much irritation and the viewer who is really interested can further examine the products of the advertiser by simply pressing a button.

A similar option also exists on the internet. It is of course possible to include an internet address in the part-image, but this requires the viewer having to make the effort to retrieve further information. Considerably less effort is required of the viewer when a reference to the internet address is integrated in the signal. When the viewer has at his disposal a video playback device suitable for reproducing TV or video images and for displaying internet images, such as PCS provided with a TV-card, or TV sets provided with an internet option, this coupling can be performed immediately. Such a coupling is otherwise also possible in the case of “normal” advertising segments with images extending over the whole image.

The present invention further relates to a device for generating such a video signal.

The construction of such a device will otherwise be self-evident to a skilled person in the relevant field; the technique will not differ greatly from the technique used to present channel identification in the corner of the image. Provisions must however be made in order to perform the measures of the sub-claims.

The invention also relates to the devices which provide a direct coupling to teletext and internet as elucidated above.

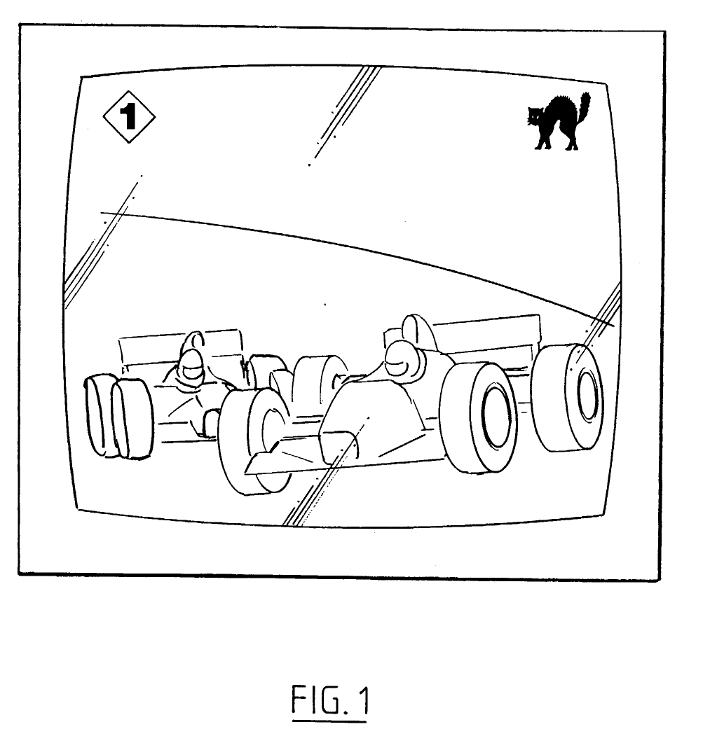

For the purpose of elucidating the invention a TV set 1 is shown in FIG. 1, which reproduces an image formed by a normal scene, in this case an image of a motor race. As known from the prior art, a window with a “1” is herein reproduced in the left-hand top corner as identification symbol for the channel “Nederland 1”. Reproduced in the top right-hand corner as a form of advertising is a symbol of a cat as advertising for for instance cat food. It is of course possible to connect the part-image to a sound signal. In view of its disruptive nature this does not however seem advantageous.

The part-image is preferably difficult to remove from the video signal, such as can be done by known video recorders in the case of advertising segments, for which purpose the programme for recording is interrupted during recording of a programme.

It will be apparent that it is possible to vary the reproduced configuration in numerous ways without departing from the present invention.

1. TV-video signal for transmitting via the broadcasting system which is adapted to represent a scene for transmitting via the broadcasting system and which is adapted to reproduce in the scene a part-image which fills a part of the image and which is independent of the scene, characterized in that the part-image represents an advertising message.

2. Video signal as claimed in claim 1, characterized in that the video signal is analog.

3. Video signal as claimed in claim 1 or 2, characterized in that the part-image is placed in a corner of the image.

4. Video signal as claimed in claim 1 or 2, characterized in that the part-image is placed along a side of the image.

5. Video signal as claimed in claim 1 or 2, characterized in that the part-image is enclosed by the scene and that the scene is adapted to reproduce the part-image.

6. Video signal as claimed in one of the preceding claims, characterized in that the part-image changes location through time.

7. Video signal as claimed in any of the foregoing claims, characterized in that the part-image changes through time.

8. Video signal as claimed in claim 6 or 7, characterized in that the changes in the part-image or in its location are linked to changes of scene.

9. Video signal as claimed in any of the foregoing claims, characterized in that the part-image is intermittent.

10. Video signal as claimed in any of the foregoing claims, characterized in that the scene shown on the part-image anticipates a subsequent advertising message which fills the whole image.

11. Video signal as claimed in any of the foregoing claims, characterized in that the part-image comprises a reference to an internet address of the advertiser of the advertising message.

12. Video signal as claimed in any of the foregoing claims, characterized in that the signal comprises a reference to the internet address of the advertiser of the advertising message.

13. Video signal as claimed in any of the foregoing claims, characterized in that the signal comprises an electronic reference to a teletext page.

14. Video signal as claimed in claim 13, characterized in that the teletext page comprises information relating to the advertiser.

15. Apparatus for generating a video signal, characterized by means for combining a video signal representing a normal scene and a signal representing the part-image to form a video signal as claimed in any of the foregoing claims.
